(19) United States
(12) Patent Application Publication
(10) Pub. No.: US 2004/0205522 A1
(43) Pub. Date: Oct. 14, 2004

(54) Customer service evaluation format

(76) Inventor: Helen Harrison, Las Vegas, NV (US)

Correspondence Address: Helen Harrison, President & COO, Alert Consultants LLC, Suite 200, 10120 Eastern Avenue, Henderson, NV, 89052, US

(21) Appl. No.: 10/145,308

(22) Filed: May 15, 2002

(51) Int. Cl. G06F 17/24

(52) U.S. Cl. 715/503

(57) ABSTRACT

The element that separates Customer Service Evaluation Format from other evaluations forms is simplicity of pertinent facts displayed in an at glance layout. In today's busy Corporate World, time is money. To alleviate unnecessary information (as in the structure of Customer Service Evaluation Format displaying only relevant information in visual as well as composition form), is the major factor influencing operating efficiency or bottom line revenue. TIME IS MONEY!

### CROSS-REFERENCE TO RELATED APPLICATIONS

N/A

### STATEMENT REGARDING FEDERALLY SPONSORED RESEARCH OR DEVELOPMENT

This design is not subject to any federally sponsored research and/or development.

### REFERENCE TO SEQUENCE LISTING, A TABLE, OR A COMPUTER PROGRAM LISTING COMPACT DISK APPENDIX

Table data shall be submitted to represent the design for patent. The data is as follows:

1. Graphs

a. Individual Category Percentage Achieved

b. Overall Total Percentage Achieved

2. Specific Observation Spreadsheet

3. Department Comparison Graph

4. Shift Comparison Graphs

5. Employee/Shift Performance Spreadsheet/Graphs

Each portion of the data is displayed in an 8½″×11″ clear sheet protector to allow for easy access and visual effects.

### BACKGROUND OF THE INVENTION/DESIGN

Although graphs and spreadsheets have been used and are still being used to display data, Alert Consultants, LLC feels that the particular emphasis and design of the Customer Service Evaluation Format is unique. The design will portray an at glance analysis of an employee's proficiencies and/or deficiencies of his/her performance standards as required by the organizational goals of the company. This format will allow the company to praise proficient performance/behavior and offer assistance in deficient performance/behavior on an individual basis. The design will also allow the company to cross compare employees performance as well as evaluate different shifts and departments (without revealing the performance level of one employee to another).

This format was designed to alleviate irrelevant data not pertaining to the organizational goals of the company for whom the employee is performing his/her responsibilities. The simplicity of the format will also assist in bridging the communication gap between employees and managers.

The design is applying for a patent under the Small Entity Utility Patent. Alert Consultants, LLC is a small Corporation specializing in customer service evaluations, operational standards and integrity audits.

### BRIEF SUMMARY OF THE INVENTION/DESIGN

The design of Customer Service Evaluation Format originated when Helen Harrison, President & COO of Alert Consultants, LLC, was employed with a major Hotel and Casino as a manager overseeing hundreds of employees. After an attempt to decipher employee evaluation audits performed by an organization not familiar with the organizational goals of the Company, revealing observations founded that the standards used were not compatible with the organizational goal required to perform the responsibilities and expectations as requested by management. Thus, Ms. Harrison designed a system that would display pertinent information about employee performance, according to the organizational goals of the company, without reading excessive amounts of irrelevant data. Special emphasis should focus on those standards which must be recognized and adhered to that will provide management and employees with sufficient detailed information to assist in efforts to improve employee performance, develop an in-depth understanding of the determinants of productivity, obtain employee and management feedback on the practices and expectations of responsibilities, and establish an on-going benchmark for customer service standards that will enhance operating efficiency.

### BRIEF DESCRIPTION OF THE SEVERAL VIEWS OF THE DRAWING

(See Attached)

FIG. 1A—Percentage Graphs displaying individual performance and/or expectations of employee achievement according to company guidelines.

FIG. 1B—Percentage Graph displaying the overall total achievement of an employee's performance and/or expectations according to company guidelines.

FIG. 2—Specific Observation Spreadsheet evaluates the employee's performance by an established scoring system to assure uniformity and equality of evaluation results. When deficiencies in company standards occur, an explanation is rendered for the less than proficient score. A brief summary is given from a customer's perspective.

FIG. 3—Department Comparison Graph displays how each department service standards compare to other departments service standards in the Company.

FIG. 4—Shift Comparison not only gives service evaluations amongst the different shifts (day shift, swing shift, and graveyard shift) but the graphs also show department shift analysis.

FIG. 5—Employee/Shift Performance Spreadsheet gives a comparative analysis of employees on same shift as well as different shifts. The spreadsheet also displays a graph at the bottom of the data to show the performance percentage achieved by the shift.

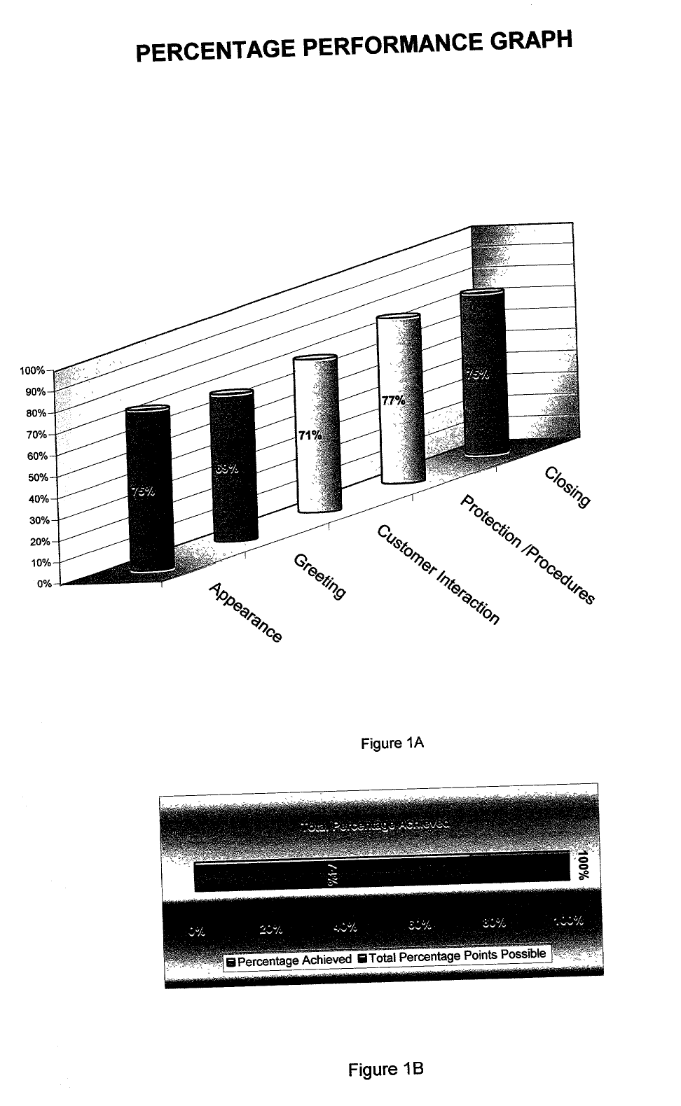

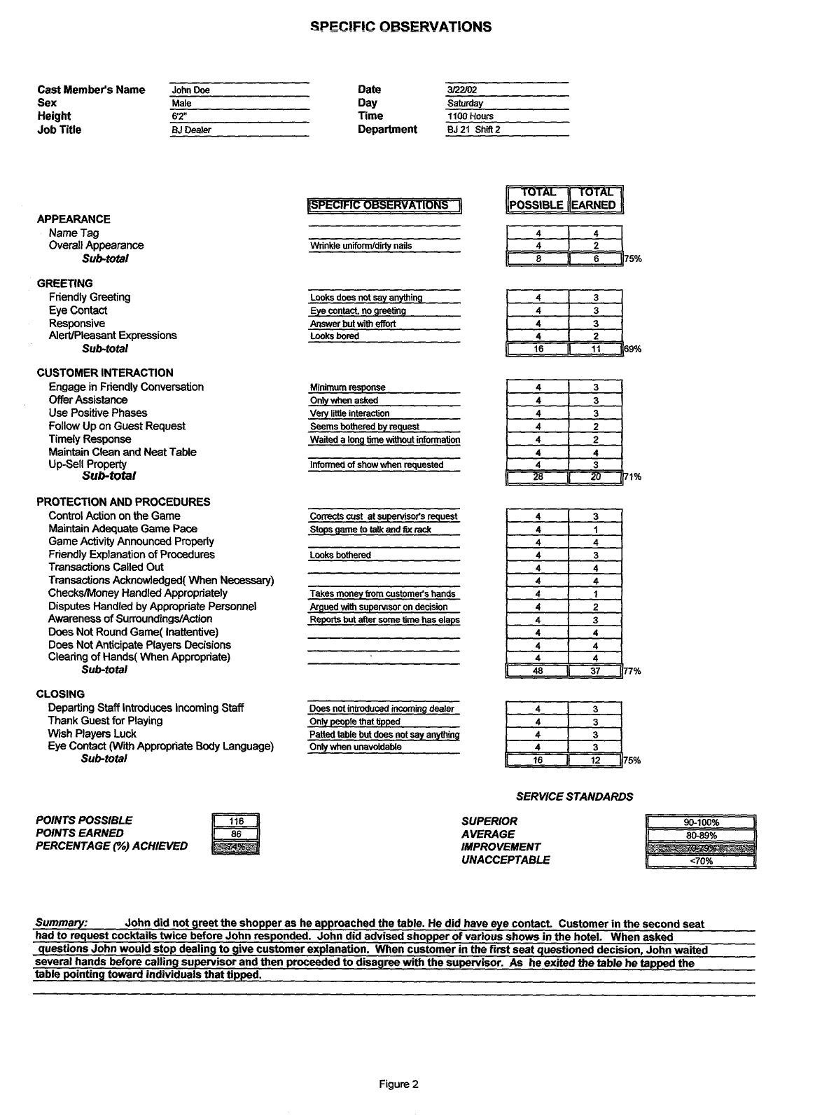

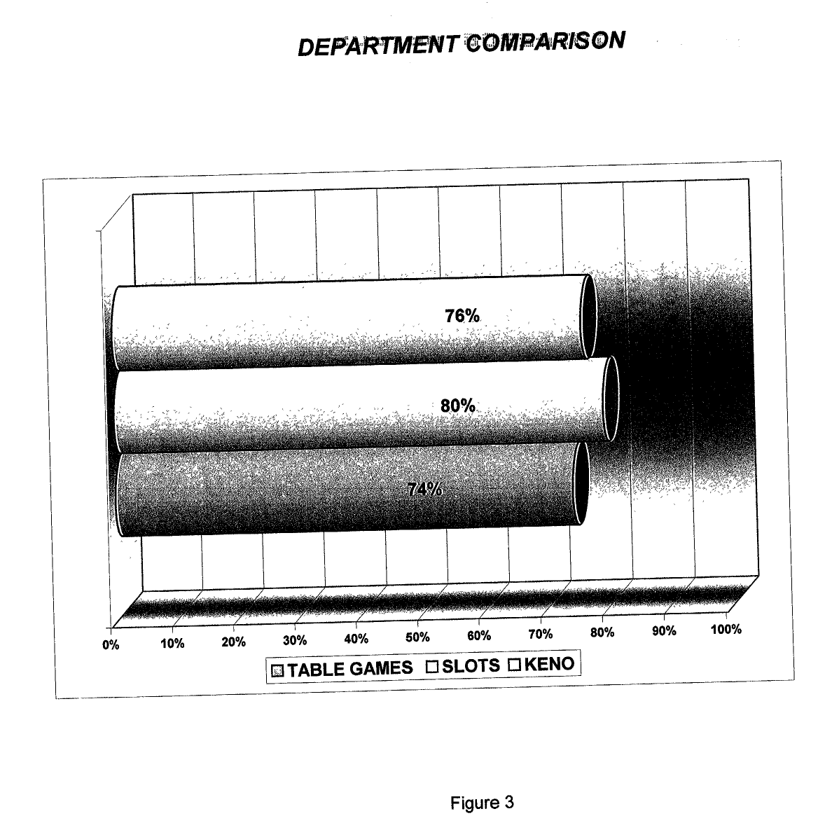

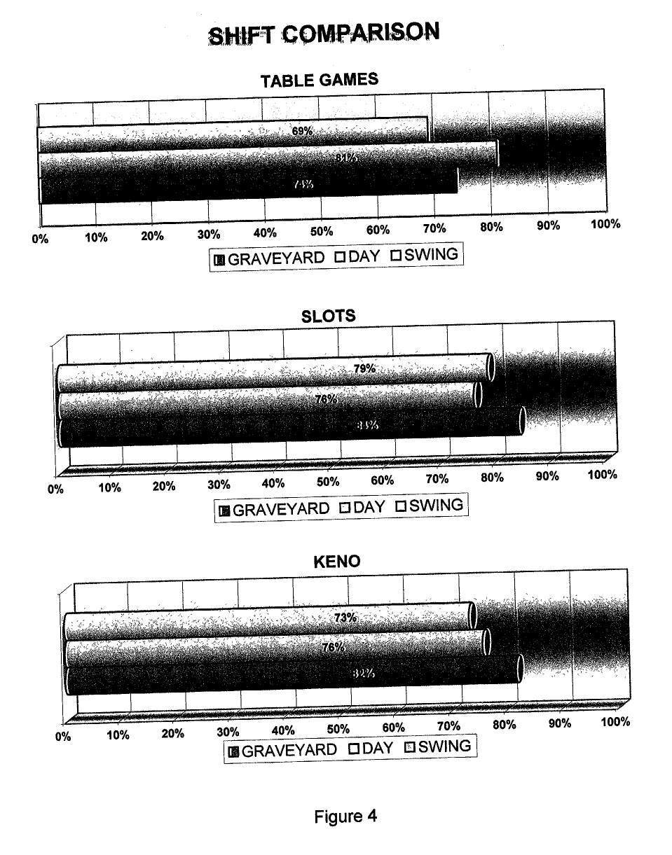

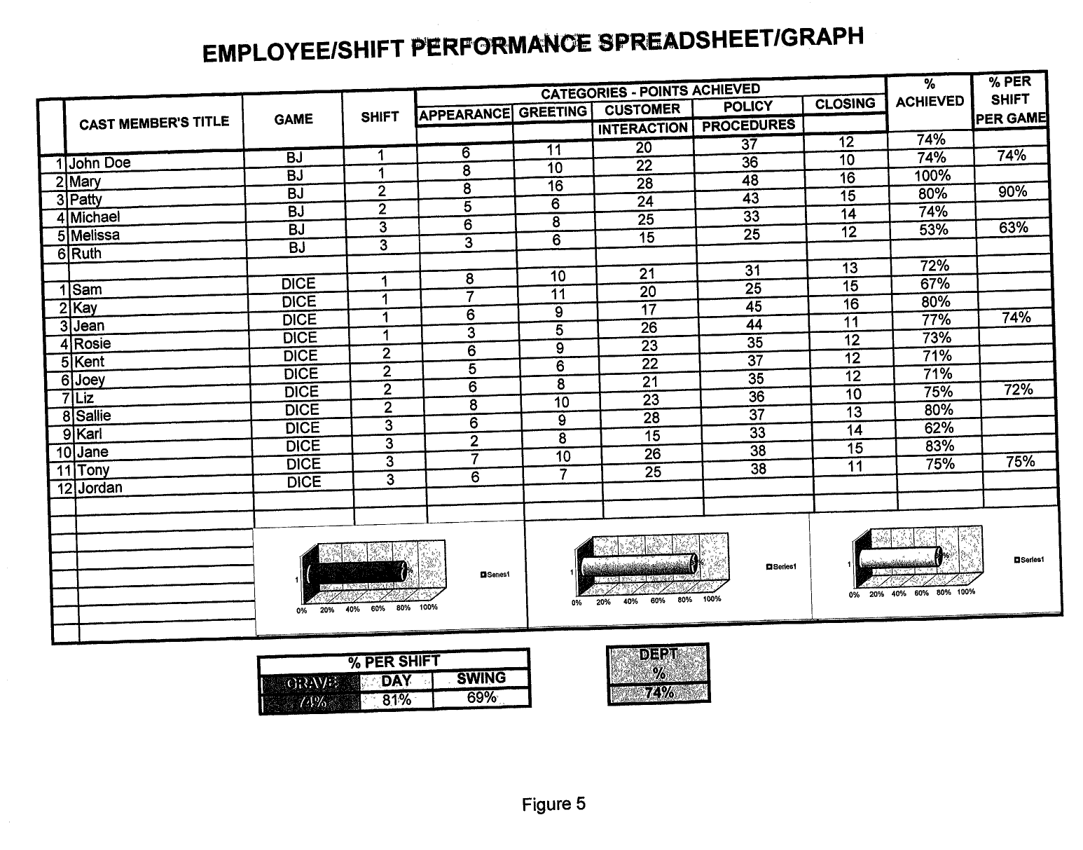

### DETAILED DESCRIPTION OF INVENTION/DESIGN

The Customer Service Evaluation Format begins with a spreadsheet. The spreadsheet outlines the Company's criteria for evaluation. Categories for evaluation may include but is not limited to:

Employee Appearance

Customer Interaction

Greeting (Arriving and Departing)

Policies and Procedures

Transactions

Closing

Each spreadsheet is specifically designed for the Corporation or Company being serviced.

A scoring system assures uniformity and equality to employee evaluation results. The system will be valued by a composition of points ranging from 1 (minimum obtainable) to 4 (most proficient). The spreadsheet will be formatted with mathematical formulas to form the graphs that display the percentages achieved in conjunction with the categories. The same principal will be used to display the shit/department comparisons.

The combination of the two components of the Customer Service Evaluation Format will provide an at glance assessment for customer service evaluations.

### SEQUENCE LISTING (WHEN NECESSARY)

N/A

What I claim as my devise/design is simplified reference tools illustrating service standards to increase proficiency and profitability of a company's operating efficiency:

1. This devise/design as it applies to customer service standards is a devise/design made up of five components.
1. First Component—Visual graphs to depict an at glance representation of the proficiencies and/or deficiencies of employee performance as set forth by the guidelines of the Company's service standards.
2. Second Component—Spreadsheet (with mathematical formulas) that presents the data that formulates the at glance graphs.
3. Third Component—Departmental Graph depicting a comparative analysis of employee performance between departments
4. Fourth Component—Shift/Department Graphs displaying a comparative analysis between departments as well as a comparative analysis amongst shifts.
5. Fifth Component—Spreadsheet (with mathematical formulas) that links the shift/department graphs together to form the comparison graphs. As data changes or updates on the spreadsheet, all data on corresponding sheets and graphs update and change.
Thus, I am claiming that the design, even though graphs or spreadsheets have been used in the past to display data, is unique in the customer service industry to depict performance standards. Customer Service Evaluation Format in particular provides an easy format to bridge the communication gap between employees and managers, which allows for feedback for increased proficiency (operating efficiency).
